(19) United States
(12) Patent Application Publication
(10) Pub. No.: US 2026/0103627 A1
(43) Pub. Date: Apr. 16, 2026

(54) BONDED STRUCTURE

(71) Applicant: Henkel AG & Co. KGaA, Duesseldorf (DE)

(72) Inventors: Stefanie Stapf, Velbert (DE); Lucas Stricker, Duesseldorf (DE); Mathias Kundt, Henkelstrasse 67 (DE); Christian Ramm, Duesseldorf (DE); Alexandra Lieske, Duesseldorf (DE)

(21) Appl. No.: 19/410,525

(22) Filed: Dec. 5, 2025

Related U.S. Application Data
(63) Continuation of application No. PCT/EP2024/062718, filed on May 8, 2024.
(60) Provisional application No. 63/471,070, filed on Jun. 5, 2023.

(51) Int. Cl. C09J 9/02; C09J 7/38; C09J 133/08; C09J 163/00

(52) U.S. Cl. CPC C09J 9/02; C09J 7/38; C09J 133/08; C09J 163/00; C09J 2301/502; C09J 2400/163; C09J 2433/00; C09J 2463/00

(57) ABSTRACT

The present invention relates to a bonded structure comprising a first substrate, having an electrically conductive surface or a non-conductive surface; a first cured adhesive layer or a first cured electrochemically debondable adhesive layer; an electrically conductive foil; a second cured electrochemically debondable adhesive layer, which may be same or different than the first cured electrically debondable adhesive layer; and a second substrate, having an electrically conductive surface, wherein the first cured adhesive layer is disposed between the first substrate and the electrically conductive foil, and wherein the second cured adhesive layer is disposed between the second substrate and the electrically conductive foil. The bonded structure can be debonded by applying a voltage across the surfaces of selected substrates.

### TECHNICAL FIELD

The present invention is directed to a bonded structure, which has been formed by using a curable and debondable adhesive composition and can be debonded from particular substrates to which it is applied.

### BACKGROUND OF THE INVENTION

Adhesive bonds and polymeric coatings are commonly used in the assembly and finishing of manufactured goods. They are used in place of mechanical fasteners, such as screws, bolts and rivets, to provide bonds with reduced machining costs and greater adaptability in the manufacturing process. Adhesive bonds distribute stresses evenly, reduce the possibility of fatigue and seal the joints from corrosive species.

Whilst adhesive bonds thus offer many advantages over mechanical fasteners, it tends to be difficult to disassemble adhesively bonded objects where this is required in practical applications. The removal of the adhesive through mechanical processes—such as by sand blasting or by wire brushing—is often precluded, in part because the adhesive is disposed between substrates and is thus either inaccessible or difficult to abrade without corrupting the substrate surfaces. Disassembly through the application of chemicals and/or high temperature might be effective but can be time consuming and complex to perform. Moreover, the aggressive chemicals and/or harsh conditions required can damage the substrates being separated, rendering them unsuitable for subsequent applications.

Therefore, there is a need for adhesives to be used in bonded structures which can be debonded without damaging the substrates.

### SHORT SUMMARY OF THE FIGURES

FIG. 1 illustrates the bonded structure according to the present invention.

FIGS. 2a, 2b and 2c illustrate the debonded structures.

### SUMMARY OF THE INVENTION

The present invention relates to a bonded structure comprising a first substrate, having an electrically conductive surface or a non-conductive surface; a first cured adhesive layer or a first cured electrochemically debondable adhesive layer; an electrically conductive foil; a second cured electrochemically debondable adhesive layer, which may be same or different than the first cured electrically debondable adhesive layer; and a second substrate, having an electrically conductive surface, wherein the first cured adhesive layer is disposed between the first substrate and the electrically conductive foil, and wherein the second cured adhesive layer is disposed between the second substrate and the electrically conductive foil.

The present invention also relates to a method of debonding the bonded structure according to the present invention, the method comprising the steps of: i) applying a voltage across surfaces of the second substrate and the electrically conductive foil or the first substrate having an electrically conductive surface and the electrically conductive foil or the electrically conductive foil or the first substrate having an electrically conductive surface and the second substrate, to form an anodic interface and a cathodic interface; and ii) debonding the surfaces.

### DETAILED DESCRIPTION OF THE INVENTION

In the following passages the present invention is described in more detail. Each aspect so described may be combined with any other aspect or aspects unless clearly indicated to the contrary. In particular, any feature indicated as being preferred or advantageous may be combined with any other feature or features indicated as being preferred or advantageous.

In the context of the present invention, the terms used are to be construed in accordance with the following definitions, unless a context dictates otherwise.

As used herein, the singular forms “a”, “an” and “the” include both singular and plural referents unless the context clearly dictates otherwise.

The terms “comprising”, “comprises” and “comprised of” as used herein are synonymous with “including”, “includes” or “containing”, “contains”, and are inclusive or open-ended and do not exclude additional, non-recited members, elements or method steps.

As used herein, the term “consisting of” excludes any element, ingredient, member or method step not specified.

The words “preferred”, “preferably”, “desirably” and “particularly” are used frequently herein to refer to embodiments of the disclosure that may afford particular benefits, under certain circumstances. However, the recitation of one or more preferable, preferred, desirable or particular embodiments does not imply that other embodiments are not useful and is not intended to exclude those other embodiments from the scope of the disclosure.

As used throughout this application, the word “may” is used in a permissive sense—that is meaning to have the potential to—rather than in the mandatory sense.

The recitation of numerical end points includes all numbers and fractions subsumed within the respective ranges, as well as the recited end points.

All percentages, parts, proportions and then like mentioned herein are based on weight unless otherwise indicated.

When an amount, a concentration or other values or parameters is/are expressed in form of a range, a preferable range, or a preferable upper limit value and a preferable lower limit value, it should be understood as that any ranges obtained by combining any upper limit or preferable value with any lower limit or preferable value are specifically disclosed, without considering whether the obtained ranges are clearly mentioned in the context.

All references cited in the present specification are hereby incorporated by reference in their entirety.

Unless otherwise defined, all terms used in disclosing the invention, including technical and scientific terms, have the meaning as commonly understood by one of the ordinary skilled in the art to which this invention belongs to. By means of further guidance, term definitions are included to better appreciate the teaching of the present invention.

The present invention relates to a bonded structure comprising a first substrate, having an electrically conductive surface or a non-conductive surface; a first cured adhesive layer or a first cured electrochemically debondable adhesive layer; an electrically conductive foil; a second cured electrochemically debondable adhesive layer, which may be same or different than the first cured electrically debondable adhesive layer; and a second substrate, having an electrically conductive surface, wherein the first cured adhesive layer is disposed between the first substrate and the electrically conductive foil, and wherein the second cured adhesive layer is disposed between the second substrate and the electrically conductive foil.

The bonded structure according to the present invention comprises a first substrate. The first substrate may be a non-conductive substrate or a non-conductive substrate having a conductive surface or a conductive substrate.

The first substrate, when non-conductive, can be shown in the form of a layer which may be constituted by a sheet or film of a resinous material or glass. Non-limiting examples of resinous material are polybutylene terephthalate and polyamide.

The bonded structure according to the present invention comprises a second substrate. The second substrate has an electrically conductive surface.

The first substrate, when conductive, and second substrate can be shown in the form of a layer which may be constituted by a metallic film; a metallic sheet; a metallic mesh or grid; deposited metal particles; a resinous material which is rendered conductive by virtue of conductive elements disposed therein; or a conducting oxide layer. As exemplary conductive elements there may be mentioned silver filaments, single-walled carbon nanotubes and multi-walled carbon nanotubes. As exemplary conducting oxides there may be mentioned: doped indium oxides, such as indium tin oxide (ITO); doped zinc oxide; antimony tin oxide; cadmium stannate; and zinc stannate. The selection of the conductive material aside, the skilled person will recognize that the efficacy of the debonding operation may be diminished where the conductive substrates are in the form of a grid or mesh which offers limited contact with the layer of first and second cured adhesive.

The bonded structure according to the present invention comprises an electrically conductive foil. The electrically conductive foil can be a solid sheet/film/foil of electrically conductive material, or a mesh, or a set of wires made from electrically conductive material.

Preferably the electrically conductive foil is selected from the group consisting of aluminium foil and copper foil.

The bonded structure according to the present invention comprises a first cured adhesive or a first cured electrochemically debondable adhesive.

The first cured adhesive, when present, can be any ordinary commercially available structural adhesive. Only requirement for the structural adhesive is that it is suitable for adhering the first substrate and the electrically conductive foil together. The first cured adhesive is preferably selected from the group consisting of a 1 k epoxy adhesive, a 2 k epoxy adhesive, an epoxy tape adhesive, a 1 k acrylate adhesive, a 2 k acrylate adhesive, a pressure sensitive adhesive, a polyurethane adhesive, and an epoxy acrylate hybrid adhesive.

Suitable commercially available structural adhesives for use in the present invention include but are not limited to LOCTITE HHD 3128 epoxy adhesive, LOCTITE HHD 6010 polyurethane adhesive and LOCTITE HHD 8540 acrylate adhesive from Henkel Corporation.

The first cured electrochemically debondable adhesive, when present, is preferably selected from the group consisting of an electrochemically debondable 1 k epoxy adhesive, an electrochemically debondable 2 k epoxy adhesive, an electrochemically debondable epoxy tape adhesive an electrochemically debondable 1 k acrylate adhesive, an electrochemically debondable 2 k acrylate adhesive, an electrochemically debondable pressure sensitive adhesive, and an electrochemically debondable epoxy acrylate hybrid adhesive.

The bonded structure according to the present invention comprises a second cured electrochemically debondable adhesive. The second cured electrochemically debondable adhesive can be same or different than the first cured electrochemically debondable adhesive.

The second cured electrochemically debondable adhesive is preferably selected from the group consisting of an electrochemically debondable 1 k epoxy adhesive, an electrochemically debondable 2 k epoxy adhesive, an electrochemically debondable epoxy tape adhesive an electrochemically debondable 1 k acrylate adhesive, an electrochemically debondable 2 k acrylate adhesive, an electrochemically debondable pressure sensitive adhesive, and an electrochemically debondable epoxy acrylate hybrid adhesive.

The first cured electrochemically debondable adhesive and the second cured electrochemically debondable adhesive comprise a resin and an electrolyte.

Suitable resin for use in the present invention is selected from the group consisting of epoxy resin, acrylate resin and mixtures thereof.

Suitable electrolyte for use in the present invention preferably comprises at least one salt having a formula selected from the group consisting of:

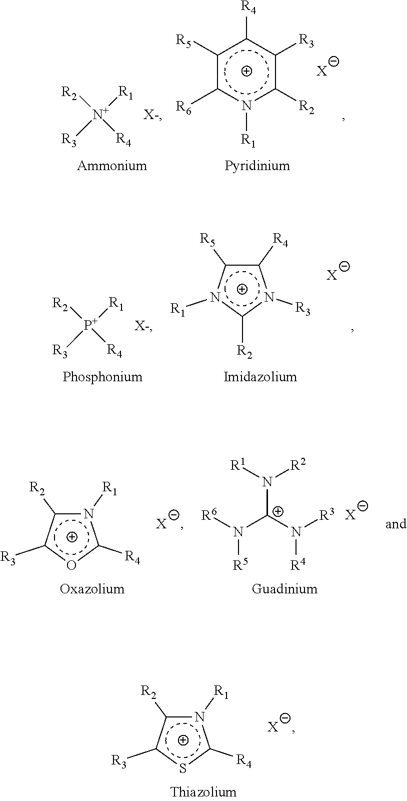

wherein: R¹, R², R³, R⁴, R⁵ and R⁶ are independently selected from hydrogen, C₁-C₁₈ alkyl, C₃-C₁₈ cycloalkyl, C₆-C₁₈ aryl, C₇-C₂₄ aralkyl, C₂-C₂₀ alkenyl, —C(O)R^{q}, —C(O)OH, —CN and —NO₂; and, R^{q} is C₁-C₆ alkyl.

For completeness, the terms C₁-C₁₈ alkyl, C₃-C₁₈ cycloalkyl, C₆-C₁₈ aryl, C₇-C₂₄ aralkyl, C₂-C₂₀ alkenyl expressly includes groups wherein one or more hydrogen atoms are substituted by halogen atoms (e.g. C₁-C₁₈ haloalkyl) or hydroxyl groups (e.g. C₁-C₁₈ hydroxyalkyl). In particular, it is preferred that R¹, R², R³, R⁴, R⁵ and Rare independently selected from hydrogen, C₁-C₁₂ alkyl, C₁-C₁₂ haloalkyl, C₁-C₁₂ hydroxyalkyl and C₃-C₁₂ cycloalkyl. For example, R¹, R², R³, R⁴, R⁵ and R⁶ may be independently selected from hydrogen, C₁-C₆ alkyl, C₁-C₆ haloalkyl and C₁-C₆ hydroxyalkyl.

There is no particular intention to limit the counter anion (X⁻) which may be employed in the electrolyte. Exemplary anions may be selected from:
Halides;
Pseudohalides and halogen-containing compounds of the formulae PF₆⁻, CF₃SO₃⁻, (CF₃SO₃)₂N⁻, CF₃CO₂⁻ and CCl₃CO₂⁻,
CN⁻, SCN⁻ and OCN⁻;
Phenates;
Sulfates, sulfites and sulfonates of the general formulae SO₄²⁻, HSO₄⁻, SO₃²⁻, HSO₃⁻, R^{a}OSO₃⁻ and R^{a}SO₃⁻;
Phosphates of the general formulae PO₄³⁻, HPO₄²⁻, H₂PO₄⁻, R^{a}PO₄²⁻, HR^{a}PO₄⁻ and R^{a}R^{b}PO₄⁻;
Phosphonates and phosphinates of the general formulae R^{a}HPO₃⁻, R^{a}R^{b}PO₂⁻ and R^{a}R^{b}PO₃⁻;
Phosphites of the general formulae: PO₃³⁻, HPO₃²⁻, H₂PO₃⁻, R^{a}PO₃²⁻, R^{a}HPO₃⁻ and R^{a}R^{b}PO₃⁻;
Phosphonites and phosphinites of the general formulae R^{a}R^{b}PO₂⁻, R^{a}HPO₂⁻, R^{a}R^{b}PO⁻ and R^{a}HPO⁻;
Carboxylic acid anions of the general formula R^{a}COO⁻;
Hydroxycarboxylic acids anions and sugar acid anions;
Saccharinates (salts of o-benzoic acid sulfimide);
Borates of the general formulae BO₃³⁻, HBO₃²⁻, H₂BO₃⁻, R^{a}R^{b}BO₃⁻, R^{a}HBO₃⁻, R^{a}BO₃²⁻, B(OR^{a})(OR^{b})(OR^{c})(OR^{d})⁻, B(HSO₄)⁻ and B(R^{a}S₄)⁻;
Boronates of the general formulae R^{a}BO₂²⁻ and R^{a}R^{b}BO⁻;
Carbonates and carbonic acid esters of the general formulae HCO₃⁻, CO₃²⁻ and R^{a}CO₃⁻;
Silicates and silicic acid esters of the general formulae SiO₄⁴⁻, HSiO₄³⁻, H₂SiO₄²⁻, H₃SiO₄⁻, R^{a}SiO₄³⁻, R^{a}R^{b}SiO₄²⁻, R^{a}R^{b}R^{c}SiO₄⁻, HR^{a}SiO₄²⁻, H₂R^{a}SiO₄⁻ and HR^{a}R^{b}SiO₄⁻;
Alkyl- and arylsilanolates of the general formulae R^{a}SiO₃³⁻, R^{a}R^{b}SiO₂²⁻, R^{a}R^{b}R^{c}SiO⁻, R^{a}R^{b}R^{c}SiO₃⁻, R^{a}R^{b}R^{c}SiO₂⁻ and R^{a}R^{b}SiO₃²⁻,
Pyridinates and pyrimidinates;
Carboxylic acid imides, bis(sulfonyl)imides and sulfonylimides of the general formulae:

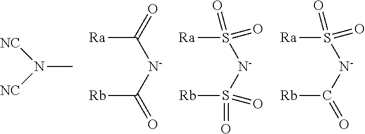

Methides of the general formula:

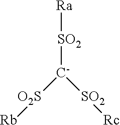

Alkoxides and aryloxides of the general formula R^{a}O⁻; and,
Sulfides, hydrogen sulfides, polysulfides, hydrogen polysulfides and thiolates of the general formulae S²⁻, HS⁻, [Sᵥ]²⁻, [HSᵥ]⁻ and [R^{a}S]⁻ in which general formulae
v is a whole positive number of from 2 to 10.
R^{a}, R^{b}, R^{c} and R^{d} are independently selected from hydrogen, a C₁-C₁₂ alkyl, C₅-C₁₂ cycloalkyl, C₅-C₁₂ heterocycloalkyl, C₆-C₁₈ aryl and C₅-C₁₈ heteroaryl.

Based on the definitions in the above list, preferred anions are selected from the group consisting of: halides; pseudohalides and halogen-containing compounds as defined above; carboxylic acid anions, in particular formate, acetate, propionate, butyrate and lactate; hydroxycarboxylic acid anions; pyridinates and pyrimidinates; carboxylic acid imides, bis(sulfonyl)imides and sulfonylimides; sulfates, in particular methyl sulfate and ethyl sulfate; sulfites; sulfonates, in particular methansulfonate; and, phosphates, in particular dimethyl-phosphate, diethyl-phosphate and di-(2-ethylhexyl)-phosphate.

Suitable electrolyte is preferably selected from the group consisting of 1-methylimidazolium bis(trifluoromethylsulfonyl)imide; 3-methylimidazolium bis(trifluoromethylsulfonyl) imide; 1-ethyl-3-methylimidazolium bis(trifluoromethylsulfonyl)imide; 1-propyl-3-methylimidazolium bis(trifluoromethylsulfonyl)imide; 1-butyl-3-methylimidazolium bis(trifluoromethylsulfonyl) imide; 1-butyl-2,3-dimethylimidazolium bis(trifluoromethylsulfonyl)imide; 1-hexyl-3-methylimidazolium bis(trifluoromethylsulfonyl)imide; 1-octyl-3-methylimidazolium bis(trifluoromethylsulfonyl)imide; 1-methyl-3-octylimidazolium bis(trifluoromethylsulfonyl) imide; 1-decyl-3-methylimidazolium bis(trifluoromethylsulfonyl)imide; 1-dodecyl-3-methylimidazolium bis(trifluoromethylsulfonyl)imide; tetraethylphosphonium bis(trifluoromethylsulfonyl)imide; tetrabutylphosphonium bis(trifluoromethylsulfonyl)imide; tridecyl(tetradecyl)phosphonium bis(trifluoromethylsulfonyl)imide; trihexyltetradecylphosphonium bis(trifluoromethylsulfonyl)amide; 1-butyl-3-methylimidazolium bis(fluorosulfonyl)imide; 1-butyl-3-methylimidazolium bis(trifluoromethylsulfonyl)imide; 1-dodecyl-3-methylimidazolium bis(trifluoromethylsulfonyl)imide; and mixtures thereof.

The first cured electrochemically debondable adhesive and the second cured electrochemically debondable adhesive will typically comprise additional components. Selection of the additional components depends on the used resin and whether the composition is 1 k or 2 k composition. The additional components are exemplified more in detail in the examples below.

As noted above, the present invention provides a bonded structure comprising a first substrate, having an electrically conductive surface or a non-conductive surface; a first cured adhesive layer or a first cured electrochemically debondable adhesive layer; an electrically conductive foil; a second cured electrochemically debondable adhesive layer, which may be same or different than the first cured electrically debondable adhesive layer; and a second substrate, having an electrically conductive surface, wherein the first cured adhesive layer is disposed between the first substrate and the electrically conductive foil, and wherein the second cured adhesive layer is disposed between the second substrate and the electrically conductive foil.

To produce such a structure, the surfaces of the first and second substrates and the electrically conductive foil may be optionally pre-treated by cleaning the surfaces to remove foreign matter there from.

The adhesives, the first adhesive or the first electrochemically debondable adhesive and the second electrochemically debondable adhesive are applied by conventional application methods such as: brushing; roll coating using, for example, a 4-application roll equipment where the composition is solvent-free or a 2-application roll equipment for solvent-containing compositions; doctor-blade application; printing methods; and, spraying methods, including but not limited to air-atomized spray, air-assisted spray, airless spray and high-volume low-pressure spray.

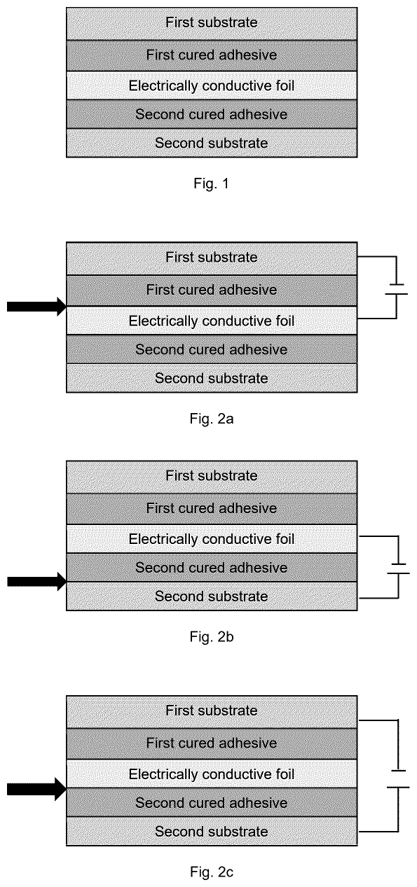

The first adhesive layer or a first electrochemically debondable adhesive layer is then applied onto an internal surface of the first substrate and the second electrochemically debondable adhesive is applied onto an internal surface of the second substrate. The electrically conductive foil is then placed on the surface of the first or second adhesive layer and the two layers then subsequently contacted, such that the electrochemically debondable adhesive compositions are interposed between the substrates and the electrically conductive foil is between the adhesive layers. The bonded structure according to the present invention is illustrated in FIG. 1.

It is recommended that the adhesives be applied to a surface at a wet film thickness of from 10 to 500 μm. The application of thinner layers within this range is more economical and provides for a reduced likelihood of deleterious thick cured regions. However, great control must be exercised in applying thinner coatings or layers so as to avoid the formation of discontinuous cured films.

The curing of the applied compositions of the invention typically occurs at temperatures in the range of from 40° C. to 200° C., preferably from 50° C. to 175° C., and in particular from 75° C. to 175° C. The temperature that is suitable depends on the specific compounds present and the desired curing rate and can be determined in the individual case by the skilled artisan, using simple preliminary tests if necessary. Of course, curing at lower temperatures within the afore mentioned ranges is advantageous as it obviates the requirement to substantially heat or cool the mixture from the usually prevailing ambient temperature.

As shown in FIG. 1 appended hereto, a bonded structure is provided in which a layer of cured first adhesive is disposed between the first substrate and the electrically conductive foil. A layer of cured second adhesive is disposed between the second substrate and the electrically conductive foil.

The present invention relates to a method of debonding the bonded structure.

The method of debonding the bonded structure according to the present invention comprising the steps of: i) applying a voltage across surfaces of the second substrate and the electrically conductive foil or the first substrate having an electrically conductive surface and the electrically conductive foil or the electrically conductive foil or the first substrate having an electrically conductive surface and the second substrate, to form an anodic interface and a cathodic interface; and ii) debonding the surfaces.

Two layers of the conductive substrates are in electrical contact with an electrical power source which may be a battery or an AC-driven source of direct current (DC). The positive and negative terminals of that power source are shown in one fixed position, but the skilled person will of course recognize that the polarity of the system can be reversed. In other words, the first substrate and the electrically conductive foil are in electrical contact with an electrical power source, or the second substrate and the electrically conductive foil are in electrical contact with an electrical power source, or both sides of the electrically conductive foil are in electrical contact with an electrical power source.

When an electrical voltage is applied between each conductive substrate, current is supplied to the adhesive composition disposed there between. This induces electrochemical reactions at the interface of the substrates and the adhesive composition, which electrochemical reactions are understood as oxidative at the positively charged or anodic interface and reductive at the negatively charged or cathodic interface. The reactions are considered to weaken the adhesive bond between the substrates allowing the easy removal of the debondable composition from the substrate.

As illustrated in FIGS. 2a, 2b and 2c, the debonding occurs at the positive interface, that interface between the adhesive composition and the electrically conductive surface that is in electrical contact with the positive electrode. Black arrow indicates the debonding site.

It is however noted that the composition of the adhesive layers may be moderated so that debonding occurs at either the positive or negative interface or simultaneously from both. For some embodiments a voltage applied across both surfaces so as to form an anodic interface and a cathodic interface will cause debonding to occur simultaneously at both the anodic and cathodic adhesive/substrate interfaces. The current can be applied with any suitable waveform, provided that sufficient total time at each polarity is allowed for debonding to occur. Sinusoidal, rectangular and triangular waveforms might be appropriate in this regard and may be applied from a controlled voltage or a controlled current source.

Without intention to limit the present invention, it is considered that the debonding operation may be performed effectively where at least one and preferably both of the following conditions are instigated: a) an applied voltage of from 0.5 to 100 V; and, b) the voltage being applied for a duration of from 1 second to 60 minutes. Where the release of the conductive substrate from the cured adhesive is to be facilitated by the application of a force—exerted via a weight or a spring, for instance—the potential might only need to be applied for the order of seconds. In some embodiments potential of 5V for a duration of 10 minutes is sufficient to have a debonding effect, whereas in some embodiments, potential of 3.5V for a duration of 30 minutes is sufficient.

It is desired that after the debonding, the adhesive composition is solely on a first substrate or a second substrate, meaning that one of the substrates is substantially free of adhesive.

The following examples are illustrative of the present invention and are not intended to limit the scope of the invention in any way.

### EXAMPLES

The following materials were employed in the Examples:

### Example 1

Parts (A) and (B) of a composition 1 were prepared in accordance with Table 1 herein below.

TABLE 1

Part A

| | | % by weight |
|---|---|---|
| Component | Weight [g] | of stated part |
| Methylmethacrylate | 5.50 | 54.98% |
| Methacrylic acid | 1.20 | 11.96% |
| 1-Ethyl-3-methylimidazolium | 1.70 | 17.00% |
| methane sulfonate | | |
| Clearstrength XT 100 | 1.42 | 14.17% |
| Aerosil 200 | 0.19 | 1.89% |
| Total | 10.0 | 100.00% |

Part B

| | | % by weight of |
|---|---|---|
| Part B | Weight [g] | stated part |
| Ferrocene | 0.02 | 0.17% |
| D.E.R. 331 | 3.61 | 36.36% |
| Benzoyl peroxid | 6.31 | 63.47% |
| Total | 10 | 100% |

The parts (A, B) were loaded in an equal amount by weight into separate compartments of a 50 g cartridge and sealed at both ends. The cartridge was then loaded into a cartridge-gun and a mixing tip was installed on the front end. By application of constant pressure on the trigger, the two parts were pushed into the mixing tip to ensure sufficient mixing before application to the stated substrate.

A bonded structure according to the present invention was prepared according to structure in FIG. 1. The first and second substrates were stainless steel and aluminium foil was an ordinary aluminium foil. The first cured electrochemically debondable adhesive layer and the second cured electrochemically debondable adhesive layer were the same adhesive according to formula in table 1.

Voltage of 30V was applied for 20 min and the adhesive bonds were easily removed at the foil side. Alternatively, the adhesive bonds were also removed easily with a specular on the stainless-steel side.

In addition, another bonded structure according to the present invention was prepared according to structure in FIG. 1. The first and second substrates were stainless steel and copper foil was used as an electrically conductive foil. The first cured electrochemically debondable adhesive layer and the second cured electrochemically debondable adhesive layer were the same adhesive according to formula in table 1.

Voltage of 30V was applied for 20 m in and the adhesive bonds were easily removed at the foil side. Alternatively, the adhesive bonds were also removed easily with a specular on the stainless-steel side.

### Example 2

Parts (A) of three two-part (21K) compositions were prepared in accordance with Table 2 hereinbelow:

TABLE 2

| | Example 1 | Example 2 | Example 3 |
|---|---|---|---|
| | (wt. % of | (wt. % of | (wt. % of |
| Part A Ingredient | Part A) | Part A) | Part A) |
| D.E.R. 337 | 33.96 | 36.89 | |
| D.E.R 331 | | | 30.02 |
| Kane Ace MX-153 | 7.55% | | 18.77 |
| EOTMPTA-AC-50 | 22.64 | 24.59 | |
| Methylmethacrylate | | | 18.77 |
| PEG400 | 1.51 | 1.64 | |
| Albiflex 296 | | | 11.25 |
| Methacrylsäure | 3.77 | 4.10 | |
| Barbitursäure | 0.38 | | |
| Erisys GE-30 | | | 2.25 |
| Casiflux G20 | 7.55 | 8.20 | |
| Shieldex AC 3 | 0.75 | 0.82 | |
| Cab-o-Sil TS 720 | 6.79 | 7.38 | 2.25 |
| 1-Ethyl-3-methylimidaz- | 15.09 | 16.39 | 16.68 |
| oliummethansulfonat | | | |

Part (B) was identically prepared for each of the three two-part (21K) compositions and in accordance with Table 3 hereinbelow:

TABLE 3

| | Examples 1-3 |
|---|---|
| Part B Ingredient | (wt. % of Part B) |
| Jeffamine EDR-176 (XTJ-590) | 45.00 |
| Jeffamine D2000 | 27.00 |
| Accelerator 2950 CH | 10.00 |
| Cab-o-Sil TS 720 | 18.00 |

For each Example, parts (A, B) were loaded into separate compartments of a 50 g cartridge and sealed at both ends. The cartridge was then loaded into a cartridge-gun and a mixing tip was installed on the front end. By application of constant pressure on the trigger, the two parts were pushed into the mixing tip to ensure sufficient mixing before application to the stated substrate. The weight ratios of Part A to Part B for the Examples were: 6.5:1 (Example 1); 7.5:1 (Example 2); and 4.5:1(Example 3).

A bonded structure according to the present invention was prepared according to the structure in FIG. 1. The first and second substrates were stainless steel and aluminium foil was an ordinary aluminium foil. The first cured electrochemically debondable adhesive layer and the second cured electrochemically debondable adhesive layer were the same adhesive according to formulas in tables 2 and 3.

Voltage of 30V was applied for 20 min and the adhesive bonds were easily removed at the foil side. Alternatively, the adhesive bonds were also removed easily with a specular on the stainless-steel side.

### Example 3

The following chemicals were used in the examples:
Duro-Tak 195A from Henkel Corporation
Duro-Tak AH115 from Henkel Corporation
Duro-Tak 183 from Henkel Corporation
1-Butyl-3-methylimidazolium bis(trifluoromethylsulfonyl)imide (BMIM NTF) from Sigma Aldrich

The compositions were prepared in accordance with Table 4.

TABLE 4

| | Example | Example | Example |
|---|---|---|---|
| Ingredient | 1 | 2 | 3 |
| Duro-Tak 195A | 90% | | |
| Duro-Tak 183 | | 90% | |
| Duro-Tak AH115 | | | 90% |
| 1-Butyl-3- | 10% | 10% | 10% |
| methylimidazolium | | | |
| bis(trifluoromethylsulfonyl) | | | |
| imide (BMIM NTF) | | | |

Compositions were prepared by mixing the ingredients. The composition was formed as a pressure sensitive film by applying the composition on a release liner (silicone foil) and subsequently heated at 110° C. for three minutes. The prepared PSA film has thickness of 120 μm.

A bonded structure according to the present invention was prepared according to the structure in FIG. 1. The first and second substrates were stainless steel and aluminium foil was an ordinary aluminium foil. The first cured electrochemically debondable adhesive layer and the second cured electrochemically debondable adhesive layer were the same PSA adhesives according to formulas in table 4.

Voltage of 30V was applied for 20 min and the adhesive bonds were easily removed at the foil side. Alternatively, the adhesive bonds were also removed easily with a specular on the stainless-steel side.

### Example 4

The following chemicals were used in the examples:
Duro-Tak 195A from Henkel Corporation
Dynacoll 7130 from Evonik
Nipol 1312LV from Zeon Chemicals
1-butyl-3-methylimidazolium bis(trifluoromethylsulfonyl)imide (BMIM TFSI) from Sigma Aldrich
1-butyl-3-methylimidazolium bis(fluorosulfonyl)imide (BMIM FSI) from Iolitec
1-dodecyl-3-methylimidazolium bis(trifluoromethylsulfonyl)imide (Dodecyl TFSI) from Iolitec

The compositions were prepared in accordance with table 5.

TABLE 5

| | Example | Example | Example |
|---|---|---|---|
| Ingredient | 1 | 2 | 3 |
| Duro-Tak 195A | 87.501 | 83.334 | 80 |
| Dynacoll 7130 | 4.166 | | |
| Nipol 1312LV | | 8.333 | 10 |
| 1-butyl-3-methylimidazolium | | | 10 |
| bis(trifluoromethylsulfonyl)imide | | | |
| (BMIM TFSI) | | | |
| 1-butyl-3-methylimidazolium | 8.333 | | |
| bis(fluorosulfonyl)imide (BMIM | | | |
| FSI) | | | |
| 1-dodecyl-3-methylimidazolium | | 8.333 | |
| bis(trifluoromethylsulfonyl)imide | | | |
| (Dodecyl TFSI) | | | |

Compositions were prepared by mixing the ingredients. The composition was formed as a pressure sensitive film by applying the composition on a release liner (silicone foil), stored it at room temperature overnight in fume hood, and subsequently heated at 110° C. for three minutes. The prepared PSA film has thickness of 120 μm.

A bonded structure according to the present invention was prepared according to the structure in FIG. 1. The first and second substrates were stainless steel and aluminium foil was an ordinary aluminium foil. The first cured electrochemically debondable adhesive layer and the second cured electrochemically debondable adhesive layer were the same PSA adhesives according to formulas in table 5.

Voltage of 30V was applied for 20 min and the adhesive bonds were easily removed at the foil side. Alternatively, the adhesive bonds were also removed easily with a specular on the stainless-steel side.

What is claimed is:

1. A bonded structure comprising
a first substrate, having an electrically conductive surface or a non-conductive surface;
a first cured adhesive layer or a first cured electrochemically debondable adhesive layer;
an electrically conductive foil;
a second cured electrochemically debondable adhesive layer, which may be same or different than the first cured electrically debondable adhesive layer; and
a second substrate, having an electrically conductive surface,
wherein the first cured adhesive layer is disposed between the first substrate and the electrically conductive foil, and wherein the second cured adhesive layer is disposed between the second substrate and the electrically conductive foil.

2. The bonded structure according to claim 1, wherein the first cured adhesive, if present, is selected from the group consisting of a 1 k epoxy adhesive, a 2 k epoxy adhesive, an epoxy tape adhesive, a 1 k acrylate adhesive, a 2 k acrylate adhesive, a pressure sensitive adhesive, a polyurethane adhesive, and an epoxy acrylate hybrid adhesive.

3. The bonded structure according to claim 1, wherein the first cured electrochemically debondable adhesive, if present, and the second cured electrochemically debondable adhesive are independently selected from the group consisting of an electrochemically debondable 1 k epoxy adhesive, an electrochemically debondable 2 k epoxy adhesive, an electrochemically debondable epoxy tape adhesive an electrochemically debondable 1 k acrylate adhesive, an electrochemically debondable 2 k acrylate adhesive, an electrochemically debondable pressure sensitive adhesive, and an electrochemically debondable epoxy acrylate hybrid adhesive.

4. The bonded structure according to claim 3, wherein the first cured electrochemically debondable adhesive and the second cured electrochemically debondable adhesive comprise a resin and an electrolyte.

5. The bonded structure according to claim 4, wherein the resin is selected from the group consisting of epoxy resin, acrylate resin and mixtures thereof.

6. The bonded structure according to claim 4, wherein the electrolyte is selected from the group consisting of 1-methylimidazolium bis(trifluoromethylsulfonyl)imide; 3-methylimidazolium bis(trifluoromethylsulfonyl) imide; 1-ethyl-3-methylimidazolium bis(trifluoromethylsulfonyl)imide; 1-propyl-3-methylimidazolium bis(trifluoromethylsulfonyl)imide; 1-butyl-3-methylimidazolium bis(trifluoromethylsulfonyl) imide; 1-butyl-2,3-dimethylimidazolium bis(trifluoromethylsulfonyl)imide; 1-hexyl-3-methylimidazolium bis(trifluoromethylsulfonyl)imide; 1-octyl-3-methylimidazolium bis(trifluoromethylsulfonyl)imide; 1-methyl-3-octylimidazolium bis(trifluoromethylsulfonyl) imide; 1-decyl-3-methylimidazolium bis(trifluoromethylsulfonyl)imide; 1-dodecyl-3-methylimidazolium bis(trifluoromethylsulfonyl)imide; tetraethylphosphonium bis(trifluoromethylsulfonyl)imide; tetrabutylphosphonium bis(trifluoromethylsulfonyl)imide; tridecyl(tetradecyl)phosphonium bis(trifluoromethylsulfonyl)imide; trihexyltetradecylphosphonium bis(trifluoromethylsulfonyl)amide; 1-butyl-3-methylimidazolium bis(fluorosulfonyl)imide; 1-butyl-3-methylimidazolium bis(trifluoromethylsulfonyl)imide; 1-dodecyl-3-methylimidazolium bis(trifluoromethylsulfonyl) imide; and mixtures thereof.

7. The bonded structure according to claim 1, wherein the electrically conductive foil is selected from the group consisting of aluminium foil and copper foil.

8. A method of debonding the bonded structure according to claim 1, the method comprising the steps of:
i) applying a voltage across surfaces of
the second substrate and the electrically conductive foil
or
the first substrate having an electrically conductive surface and the electrically conductive foil
or
the electrically conductive foil
or
the first substrate having an electrically conductive surface and the second substrate,
to form an anodic interface and a cathodic interface; and
ii) debonding the surfaces.

9. The method according to the claim 8, wherein the voltage applied in step i) is from 0.5 to 100 V and it is preferably applied for a duration of from 1 second to 60 minutes.
